(19) United States
(12) Patent Application Publication
(10) Pub. No.: US 2015/0092261 A1
(43) Pub. Date: Apr. 2, 2015

(54) MICROMECHANICAL FLEXURE DESIGN USING SIDEWALL BEAM FABRICATION TECHNOLOGY

(71) Applicant: Pixtronix, Inc., San Diego, CA (US)

(72) Inventors: Tyler Dunn, North Reading, MA (US); Mark Andersson, Northborough, MA (US); Andrew William Sparks, Cambridge, MA (US); Joyce Wu, Somerville, MA (US); Hideki Nakagawa, Tokyo (JP)

(21) Appl. No.: 14/451,663

(22) Filed: Aug. 5, 2014

Related U.S. Application Data
(60) Provisional application No. 61/884,687, filed on Sep. 30, 2013.

(51) Int. Cl. G02B 26/02; G09G 3/32; G09G 3/36

(52) U.S. Cl. CPC G02B 26/02; G09G 3/36; G09G 3/3208
USPC 359/290

(57) ABSTRACT

This disclosure provides systems, methods and apparatus utilizing flexures in a display. In some implementations, an electromechanical systems (EMS) device can include flexures that have low stiffness along the axis of motion of a light modulator, and high stiffness in other directions. The flexures may include one or more beams mechanically coupling a MEMS structure to an anchor. The beams may be coupled to a hinge portion, the hinge portion being configured to suppress out of plane motion by the MEMS structure and the flexures. The flexures also may suppress out-of-plane motion using a stiffened portion. The stiffened portion can be mechanically coupled to the hinge portion or at least one beam of the flexure. By varying the cross-section geometry of the stiffened portion, the stiffness of the stiffened portion may be controlled to increase the force required to move the flexure in an out-of-plane direction.

### CROSS-REFERENCE TO RELATED APPLICATIONS

This patent application claims priority to U.S. Provisional Patent Application No. 61/884,687 filed Sep. 30, 2013 entitled “METHODS OF MICROMECHANICAL FLEXURE DESIGN USING SIDEWALL BEAM FABRICATION TECHNOLOGY,” and assigned to the assignee hereof. The disclosure of the prior application is considered part of and is incorporated by reference in this patent application.

### TECHNICAL FIELD

This disclosure relates to electromechanical systems and devices in the field of displays, and particularly to displays having MEMS compliant beam structures, and methods for designing and fabricating the same.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Certain MEMS shutter-based light modulator displays utilize mechanical microstructures, such as flexures, for moving the shutter-based light modulators relative to an aperture in a pixel. The flexures act as springs to move the light modulators in a particular plane of motion. The light modulators are designed to be compliant (have a low stiffness) in the in-plane direction of motion. However, out-of-plane motion due to vibrating, translating, rotating or twisting may cause the MEMS microstructure to fail. The failure may result in breakage of the microstructure and stiction resulting from the MEMS microstructure crashing into neighboring features.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical device, including a microelectromechanical systems (MEMS) flexure. The device having a first beam, and a second beam positioned substantially parallel to the first beam, the first beam and second beam extending in a first direction, and a hinge located at a first end of the first beam and coupling the first beam to the second beam, the hinge having a first hinge beam extending in a second direction and transverse to the first and second beam, and a stiffened portion coupled to the first hinge beam in a first location, the stiffened portion including a two-dimensional surface extending in a plane substantially parallel to a first plane.

In some implementations, a cross-section of the stiffened portion can be variable. In some implementations, the stiffened portion can be recessed in the z-direction. In some implementations, a mass of the stiffened portion can be varied through the z-direction. In some implementations, the first location can be variable. In some implementations, the first beam can be coupled to an anchor and the anchor can be attached to a substrate. In some implementations, the second beam can be coupled to a light modulator. In some implementations, the hinge can include a four-segment portion coupled to the stiffened portion. In some implementations, the electromechanical device can include a second hinge coupling the second beam to a third beam.

Another innovative aspect of the subject matter described in this disclosure can be implemented in an electromechanical device, including an anchor coupled to a substrate. The device including a first beam extending in a first direction and coupled to the anchor, a second beam extending in a second direction and coupled to the first beam, and a third beam extending in the first direction and coupled between the second beam and a light modulator, wherein at least one of the first beam, the second beam and the third beam is coupled to a stiffened portion. In some implementations, a cross-section of the stiffened portion can be variable. In some implementations, the stiffened portion can be recessed in the z-direction. In some implementations, a mass of the stiffened portion can be varied through the z-direction. In some implementations, the stiffened portion can be coupled to the anchor. In some implementations, the stiffened portion can be coupled to the light modulator. In some implementations, the light modulator can move in the first direction and substantially parallel to the substrate.

Another innovative aspect of the subject matter described in this disclosure can be implemented in an electromechanical device, including an anchor means coupled to a substrate means, a first beam means extending in a first direction and coupled to the anchor means, a second beam means extending in a second direction and coupled to the first beam means, and a third beam means extending in the first direction and coupled between the second beam means and a light modulator means, wherein at least one of the first beam means, the second beam means and the third beam means is coupled to a stiffened means. In some implementations, a cross-section of the stiffened means can be variable. In some implementations, the stiffened means can be recessed in the z-direction. In some implementations, a mass of the stiffened means can vary through the z-direction.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a shutter-based display flexure.

FIG. 4 shows a plan view of an example shutter-based display flexure having a hinge including a stiffened portion.

FIG. 5 shows an illustrative model of an example shutter-based display flexure including cross-sections of the hinge portions.

FIG. 6 shows a perspective view of an example MEMS display apparatus.

FIG. 7 shows another perspective view of an example MEMS display apparatus.

FIGS. 8 and 9 show illustrative models of example beams having complex cross-sections.

FIGS. 10A-10D show illustrative models of example cross-sections that may be used in the flexures of a shutter-based display.

FIGS. 11A and 11B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, an EMS device can include flexures that have low stiffness along the axis of motion of a light modulator, and high stiffness in other directions. The flexures may suppress out-of-plane motion of a MEMS structure within the EMS device, and thereby suppress sensitivity of the MEMS structure to shock and vibration. Additionally, the flexures may prevent crashing and subsequent failure of the MEMS structure. The flexures may include one or more beams mechanically coupling a MEMS structure (such as a light modulator) to an anchor. The beams may be coupled by a hinge portion, the hinge portion being capable of suppressing out-of-plane motion of the MEMS structure and the flexures.

The flexures also may suppress out-of-plane motion using a stiffened portion. The stiffened portion can be mechanically coupled to the hinge portion or at least one beam of the flexure. By varying the cross-sectional geometry of the stiffened portion, the stiffness of the stiffened portion may be controlled as a function of the geometry of the stiffened portion. Thus, the force required to move the flexure in an out-of-plane direction is increased as a result of the geometry of the stiffened portion. Furthermore, by varying the mass of the stiffened portion along a plane orthogonal to the plane of motion of the MEMS structure, strength and stiffness may be added to the stiffened portion without requiring the addition of substantially extra mass.

Particular implementations of the subject matter described in this disclosure can be implemented to realize one or more of the following potential advantages. The devices, systems and methods described herein may reduce out-of-plane motion of a MEMS structure by reducing vibrating, translating, rotating or twisting which may cause the MEMS structure to fail. The systems and method described herein allow for the design of flexures within the shutter-based display fabrication process to control stiffness of a portion of the flexure connected to the MEMS structure to reduce out-of-plane motion of the MEMS structure. As compared with a typical vertical sidewall beam profile, the flexure beams described herein have cross-sections which provide large moments of inertia and torsion constants, thereby suppressing out-of-plane motion. Furthermore, by stiffening the flexure near an anchor, the flexure is prevented from bowing due to stress. By reducing or eliminating bowing in the flexure, the gap between the shutter spring and drive electrode along the length of the actuator can be better controlled.

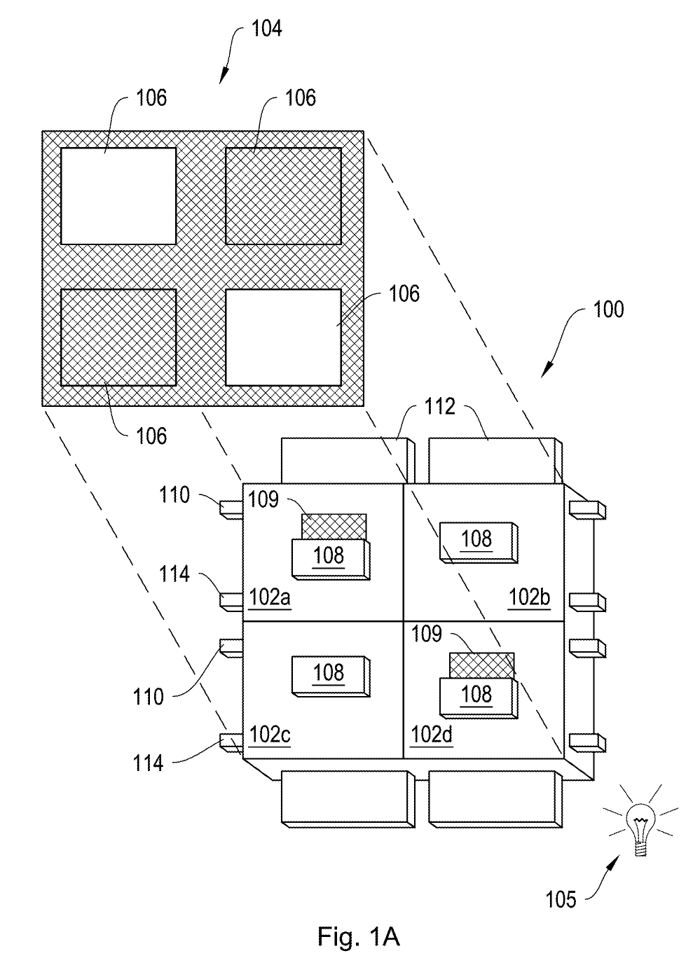

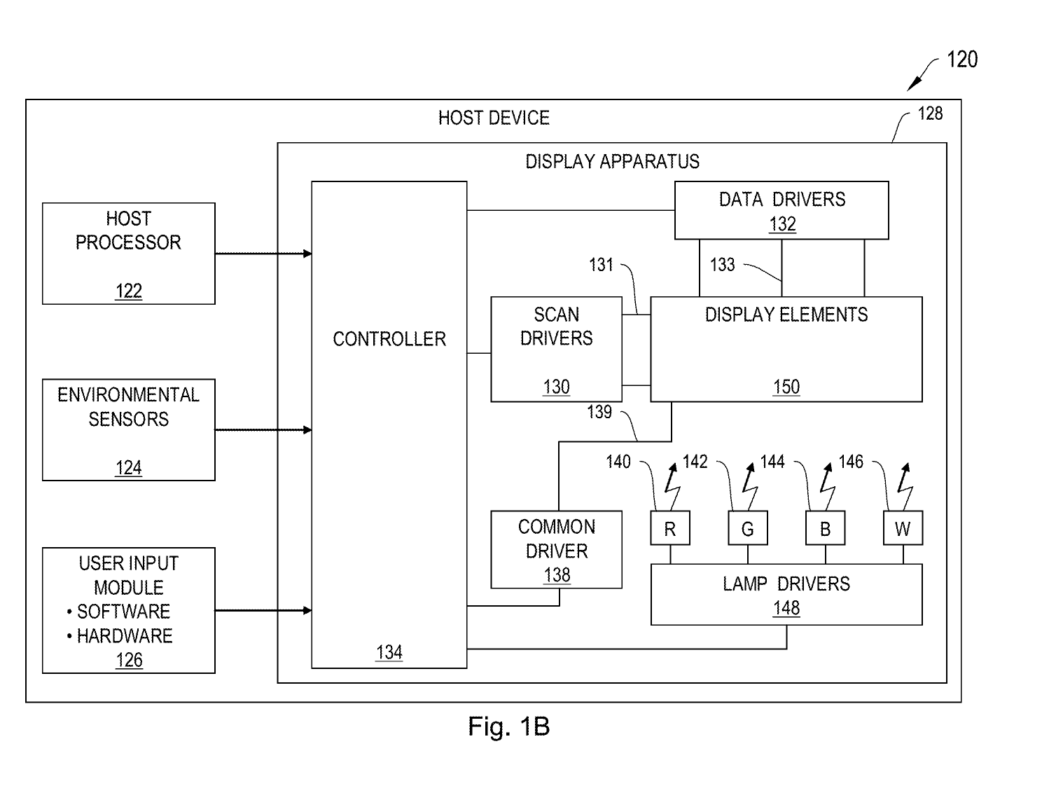

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

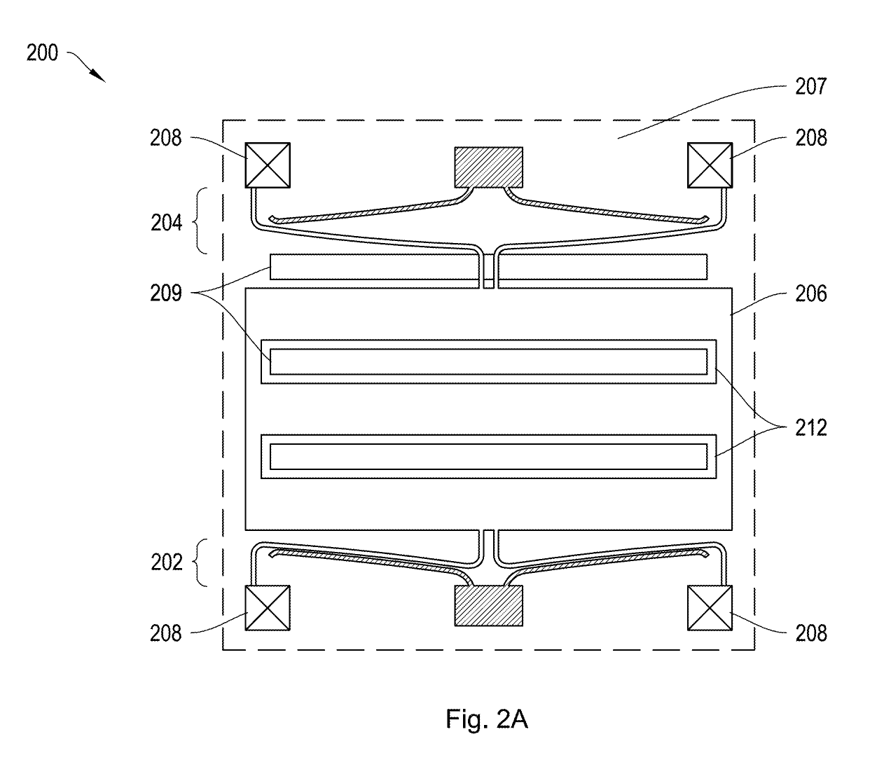

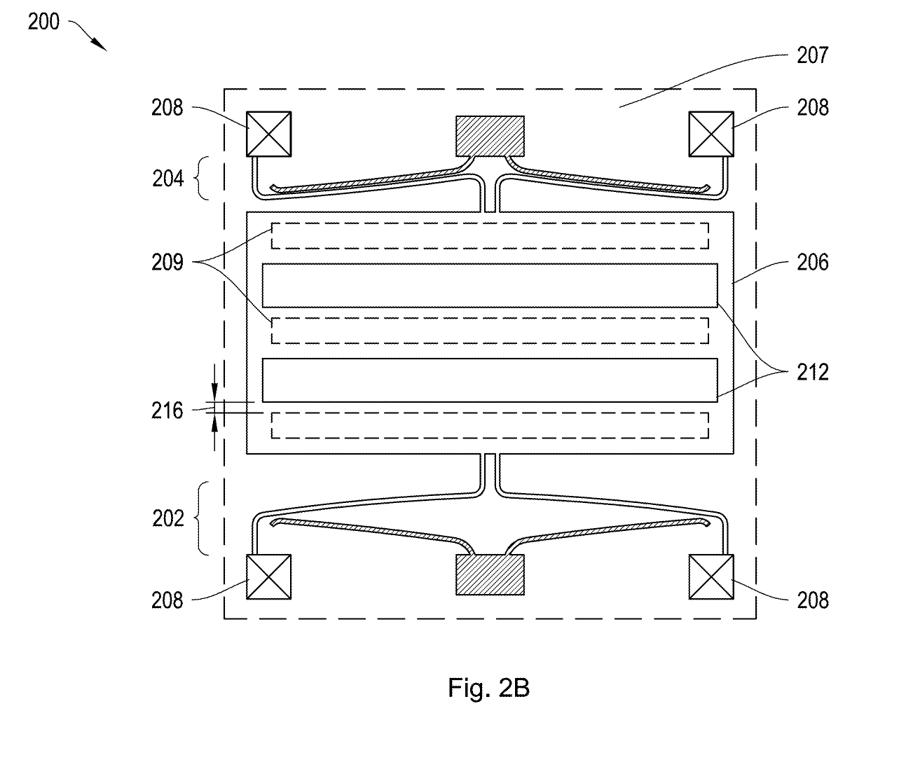

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

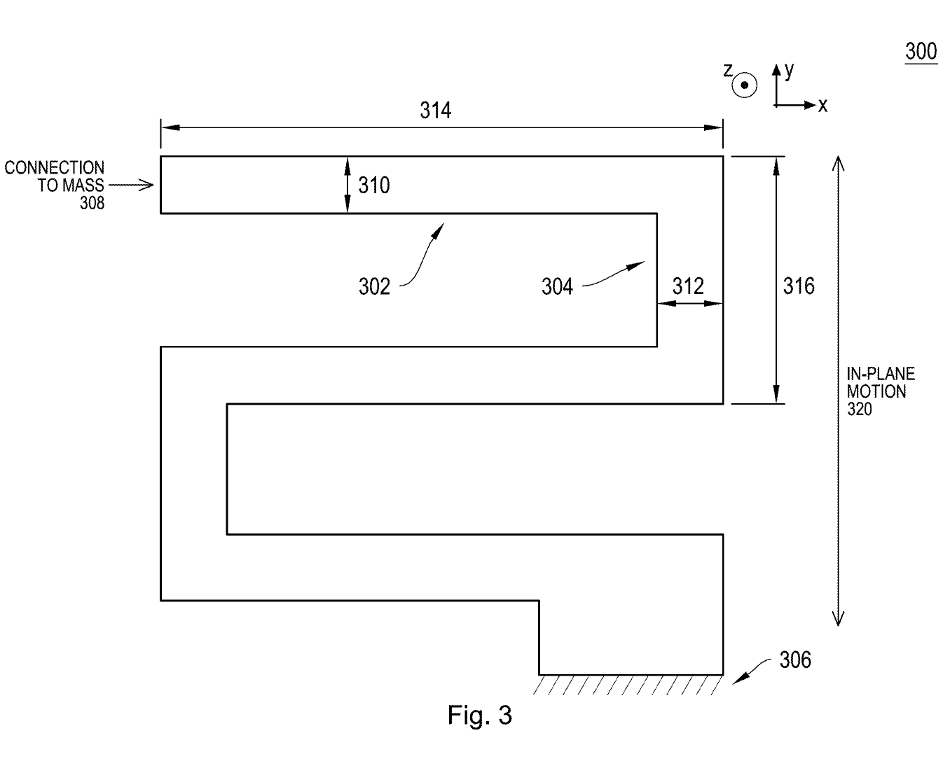

The shutter-based display flexure fabrication process employs sidewall deposition to form one or more beams making up a flexure. FIG. 3 shows a shutter-based display flexure 300. The flexure 300 includes a beam 302 having a length 314 and a width 310. Flexure 300 also includes beam 304 coupled to beam 302, and having a length 316 and a width 312. Beam 302 connects to a mass at connection point 308, (for example to a MEMS structure) and the entire flexure is coupled to an anchor 306. The flexure 300 is designed to be compliant along the y-direction, thus creating an in-plane motion 320 in the y-direction. Because the shutter-based display sidewall beam fabrication process does not allow for control of beam width, the width 310 and 312 of each beam is equal and fixed by the fabrication process. Consequently, in the flexure 300, the design thickness 312 of flexure 300 is constrained by the fabrication process and cannot be made thicker to increase stiffness reduce out of plane motion (i.e., in the x-direction or z-direction).

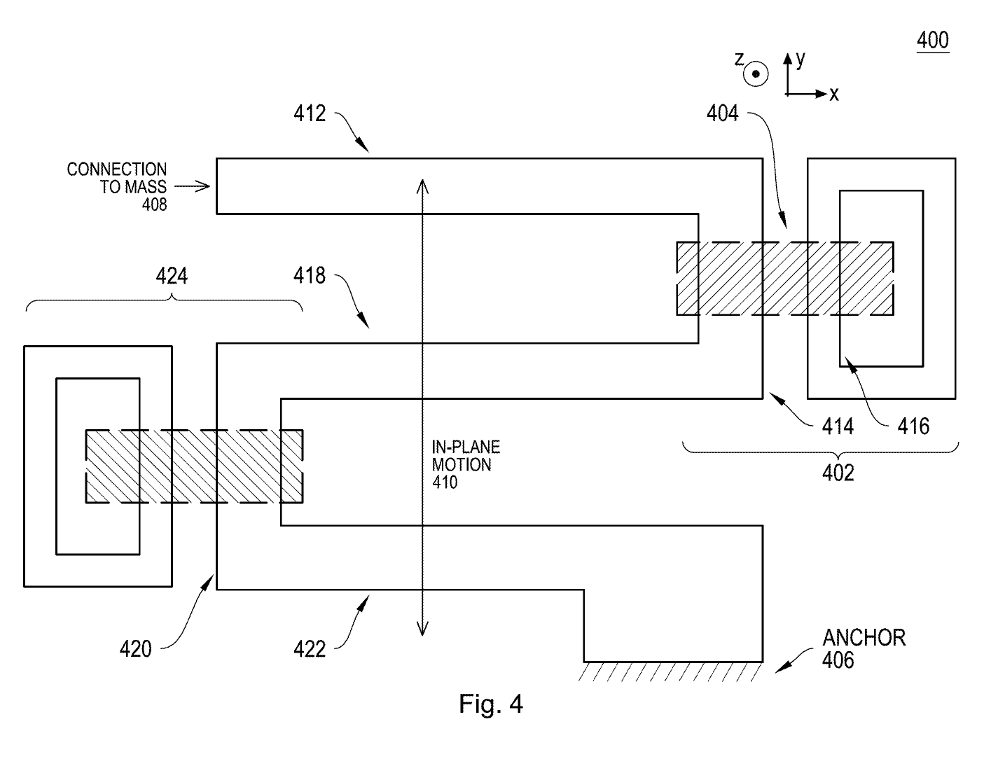

FIG. 4 shows a plan view of an example shutter-based display flexure 400 having a two hinge portions. While the shutter-based display flexure 400 is shown with two hinge portions, in some implementations the shutter-based display flexures may have more or less than two hinge portions. A hinge portion 402 includes a stiffened portion 404. The shutter-based display flexure 400 is an example of a flexure that may be used as the flexure 202 or the electrode flexure 204 as described with respect to the light modulator 200 as depicted in FIGS. 2A and 2B. The shutter-based display flexure 400 is shown having five connected beams 412, 414, 418, 420 and 422, however more or less beams may be used to create the flexure. The shutter-based display flexure 400 includes a first beam 412 extending in first direction (such as an x-direction) and a second beam 418 substantially parallel the first beam 412 and extending in the first direction. The shutter-based display flexure 400 is also shown having two hinge portions 402 and 424, however more or less hinge portions may be used to create the flexure. The hinge portion 402 includes a hinge beam 414 extending in a second direction (such as the y-direction), transverse to the beams 412 and 418, and coupling the beams 412 and 418. The beam 412 may be coupled to a mass (such as a MEMS structure) at a connection point 408. The entire flexure 400 can be coupled to an anchor 406 and thereby anchored to a substrate.

In the shutter-based display flexure 400, the beam 304 of the flexure 300, as depicted in FIG. 3, is replaced with a hinge segment 402 having an alternative geometric cross-section. The alternative geometric cross-section may include a more complex multi-segment cross-section of multiple orders. For example, FIG. 4 illustrates a flexure 400 with a hinge 402 having five segments including a stiffened portion 404 and a four-segment portion 416 coupled to the stiffened portion 404. In some implementations, the hinge portion 402 may have more or less than five segments. The higher torsion constant created by the five-segment hinge section 402 may result in strong suppression of motion in the z-direction, while still allowing for in-plane motion 410 of the MEMS structure in the y-direction. The five segments of the hinge portion 402 also may prevent twisting and translation of the flexure 400 in out-of-plane motion. By replacing the beam 304 of the flexure 300, as depicted in FIG. 3 with additional segments, the moment of inertia about the y-axis can be increased. The increased moment of inertia about the y-axis created by the multi-segment hinge section 402 can suppress rotation that would lead to out-of-plane MEMS structure movement.

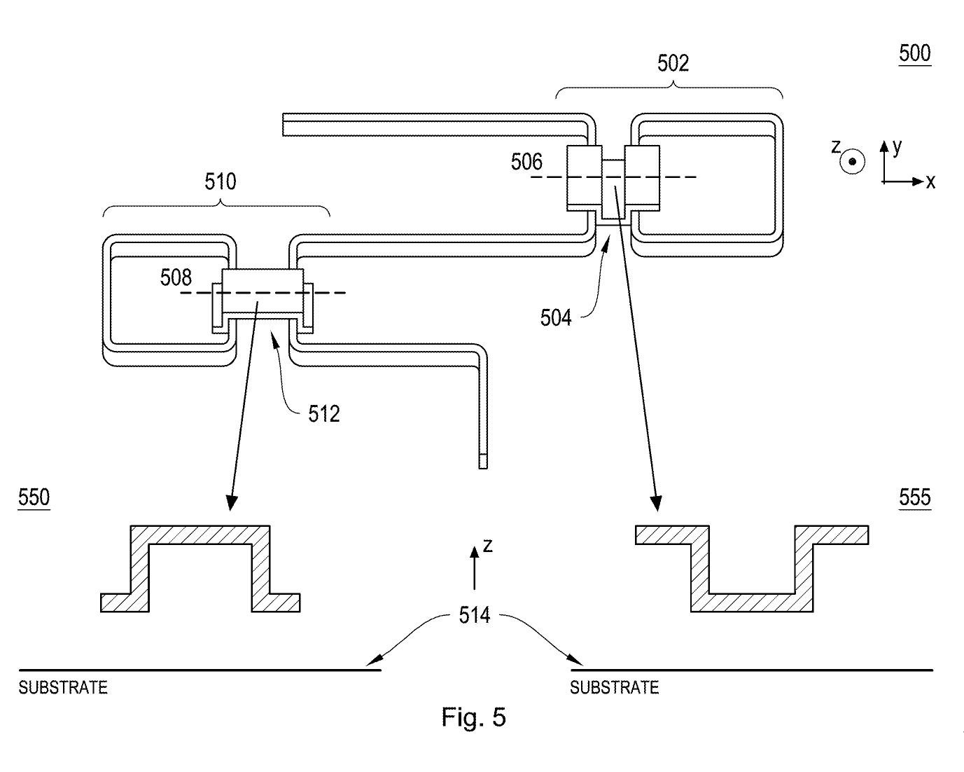

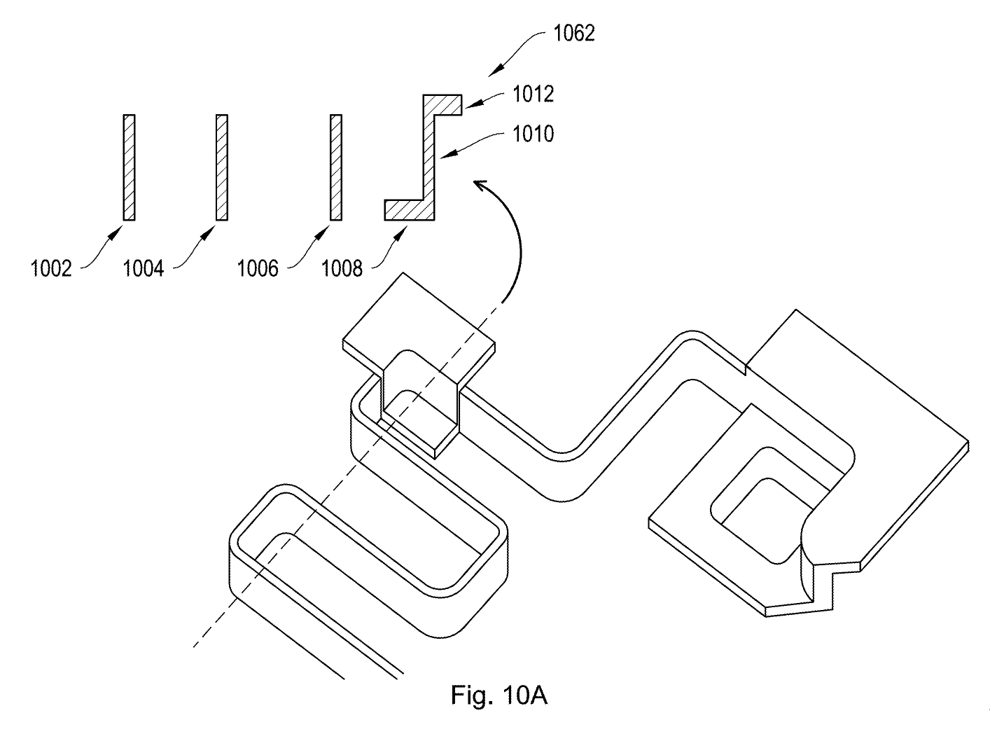

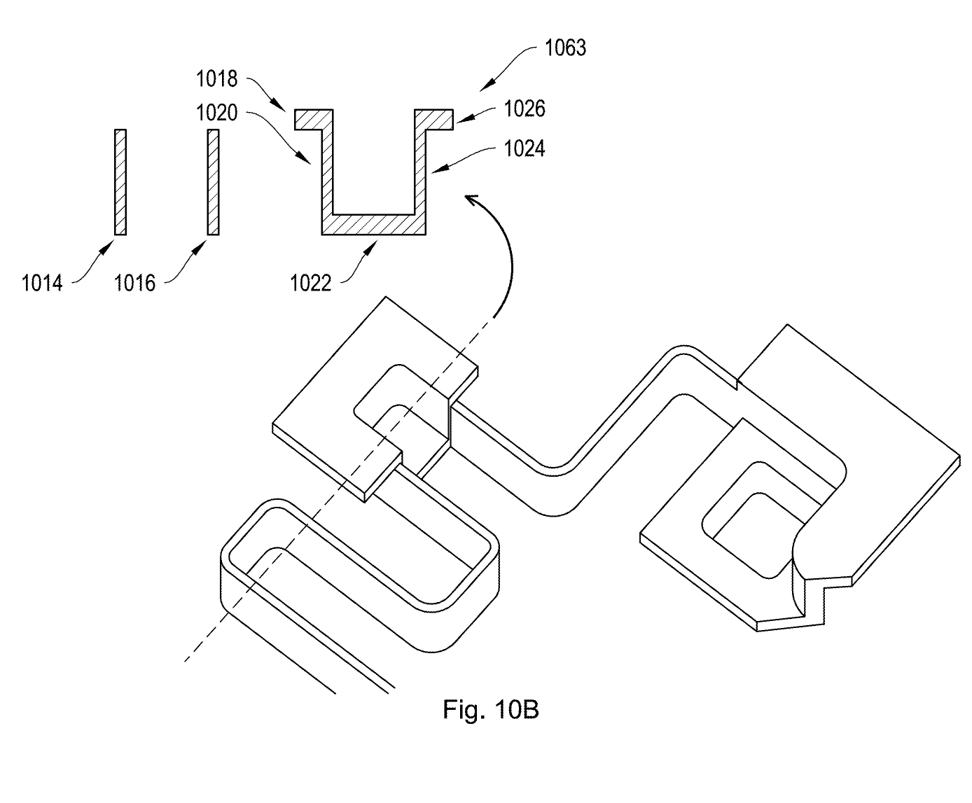

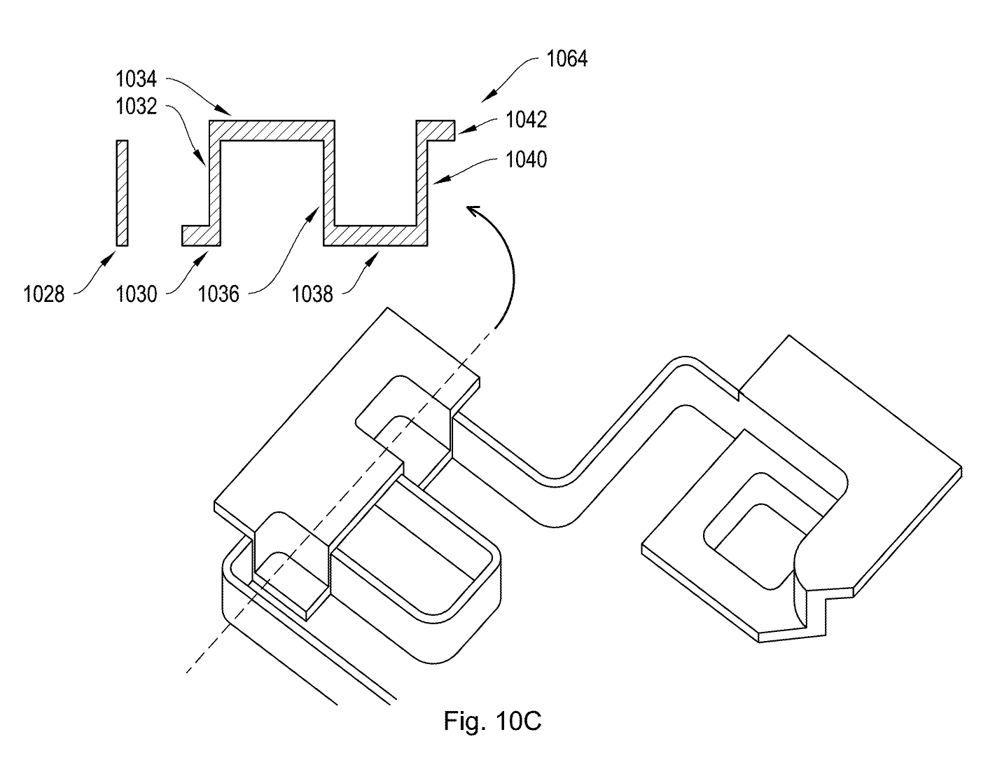

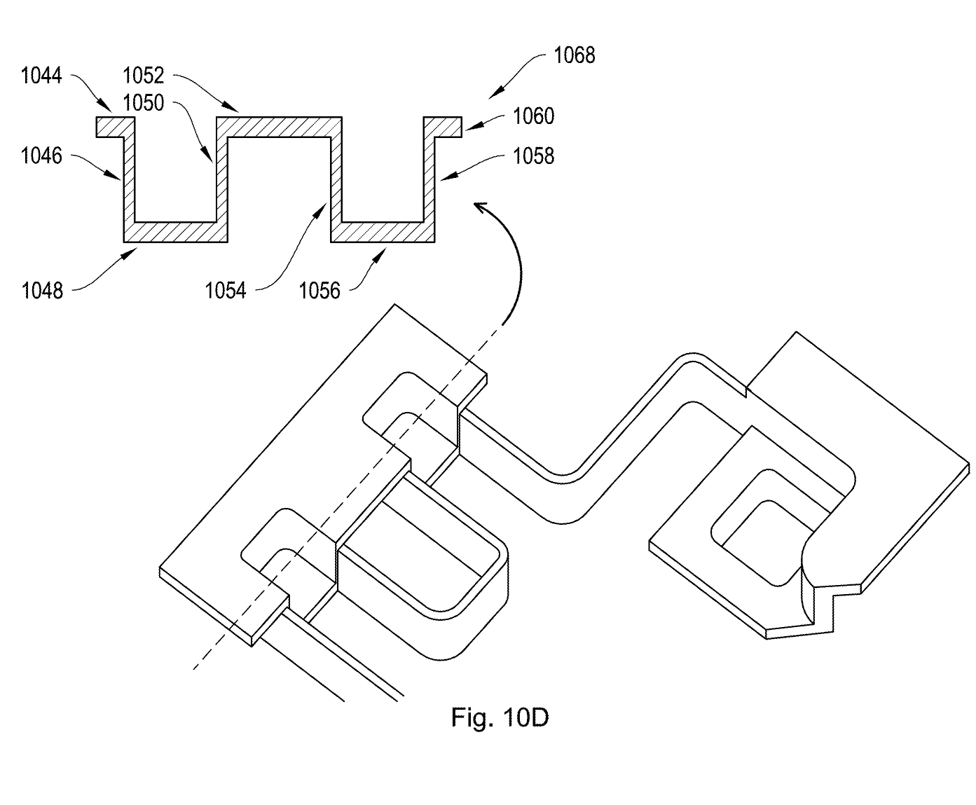

The five-segment hinge portion 402 of the flexure 400 includes a stiffened portion 404 coupled to the hinge beam 414. As shown in FIG. 4, the stiffened portion 404 is coupled to the hinge beam 414 in approximately the center of the hinge beam 414, however in some implementations the location of the stiffened portion 404 coupled to the hinge beam 414 is variable. The stiffened portion 404 may include a two-dimensional surface extending in a plane substantially parallel to an xy-plane and mechanically coupling the first hinge beam 414 to at least one other beam (such as beam 416) in the flexure. The geometry of the cross-section of the stiffened portion 404 is variable. For example, the stiffened portion 404 may be recessed in the z-direction (such as, into the page) or alternatively may be a raised portion that is raised in the z-direction (such as, out of the page), or may be a combination of the two. Furthermore, the mass of the stiffened portion 404 may be varied in the z-direction. By varying the geometry and mass of the stiffened portion 404, the out-of-plane stiffness of the flexure 400 may be increased. FIG. 5 shows an illustrative model of an example shutter-based display flexure 500 including cross-sections 550 and 555 of the stiffened portions of a flexure 500. The shutter-based display flexure 500 is an example of a flexure that may be used as the flexure 400 of FIG. 4=. The flexure 500 includes hinge portions 502 and 510. While two hinge portions are shown, the shutter-based display flexure 500 may include more or less hinge portions. The hinge portion 502 includes a stiffened portion 504. The hinge portion 510 includes a stiffened portion 512. While each hinge portion 502 and 510 includes one stiffened portion, the hinge portions 502 and 510 may include more than one stiffened portion, or, in some implementations, no stiffened portion at all. In some implementations, the shape of the stiffened portion may be different than the stiffened portions 504 and 512. For example, FIG. 10 shows various examples of different shapes of the stiffened portion.

The mass in the stiffened portions 504 and 512 is varied though the z-direction and may create a higher stiffness to reduce out-of-plane motion (such as, in the z-direction), without adding significantly more mass to the flexure. The geometry of the stiffened portion 504 can be varied in the z-direction. As shown in the cross-sections 550 and 555, the shutter-based display flexure 500, including the stiffened portions 506 and 508, is suspended above the substrate 514. In some implementations, the stiffened portion 504 is recessed in the z-direction (i.e., into the page). Viewing the cross-section 555 of the stiffened portion 504 along the line 506 shows the stiffened portion 504 being recessed toward the substrate 514. The stiffened portion 512 also can be raised in the z-direction (i.e., out of the page). Viewing the cross-section 550 along the line 508 shows the stiffened portion 512 being raised away from the substrate 514. The hinge sections 502 and 510 also may provide more stiffness in out-of-plane directions while still being fabricated using the shutter-based display fabrication process.

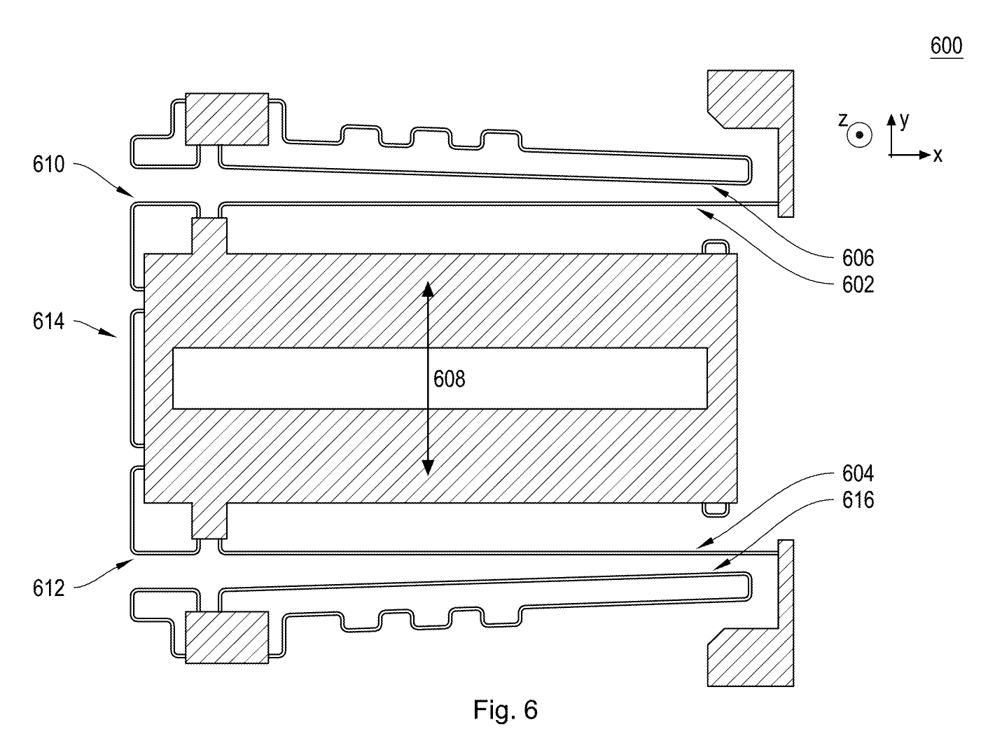

FIG. 6 shows a perspective view of an example MEMS display apparatus 600. The display apparatus 600 includes a MEMS shutter 614 of the type depicted in FIG. 2B. The display apparatus 600 of FIG. 6 may be used as the light modulators assemblies 102A-102D depicted in FIG. 1A. The MEMS shutter 614 is coupled to flexures 602 and 604. The flexures 602 and 604 include hinge portions 610 and 612, respectively. The flexures 602 and 604 may be the same type of flexures as described with respect to FIGS. 4 and 5.

Similarly to the light modulator assembly 200 of FIGS. 2A and 2B, the flexures 602 and 604 are opposite an electrode 606 and 616, respectively. The flexures 602 and 604 are compliant and move as the MEMS shutter 614 moves in its plane of motion 608. The electrodes 606 and 616 are fixed at one end, with the opposite end free to move toward flexures 602 and 604. Thus, the electrodes 606 and 616 are free to move toward the shutter and close the gap when a potential difference is applied. This can increase the actuation force and allow for lower voltage operation of the MEMS shutter 614. To move the MEMS shutter 614, a potential difference is applied between at least one of the electrodes 606 and 616 and the corresponding flexure 602 and 604 to move the shutter in the desired direction. For example, if a potential difference is applied between the electrode 606 and the flexure 602, so that the flexures 602 is attracted to the electrode 606, the flexure 602 will “flex” into the electrode 606 and “zip” up, thereby translating the MEMS shutter 614 in the y-direction. As the flexure 602 zips up to the electrode 606, the flexure 604 flexes away from the electrode 616. Because the flexures 602 and 604 are conductive, a capacitance is created between the flexures 602 and 604 and the electrodes 606 and 616. The capacitance may hold electrical charge to create an electrostatic force and hold the shutter 614 in position. In this implementation, a controller, such as the controller 156 depicted in FIG. 1B, may control the operation of each electrode-flexure combination to move the shutter 614 along the plane of motion 608 and either block light or allow light to pass through an aperture, as described with respect to FIGS. 1A, 2A and 2B.

As a result of the stiffness of the hinge portions 610 and 612, out-of-plane movement of the shutter 614 can be reduced while having minimal effect on the movement of the shutter 614 in the plane of motion 608. The hinge portions 610 and 612 also may include a stiffened portion, as described with respect to FIGS. 4 and 5. The flexures 602 and 604 may be made from any suitable material, for example the flexures 602 and 604 may be made from metals (such as Al, Ti, Cr, Mo, Ni) or semiconductors (such as Si, Ge GaAs), or stacks of multiple materials. In some implementations, one or more dielectrics (such as Al2O3, SiO2 Si3N4) can coat the flexure material. The electrodes 606 and 616 may be made from any suitable material, and for example may be made from a semiconductor material such as amorphous silicon (a-Si) or epitaxial silicon. The electrodes 606 and 616 also may be made from metals (such as Al, Ti, Cr, Mo, Ni) or semiconductors (such as Si, Ge GaAs), or stacks of multiple materials. In some implementations, one or more dielectrics (such as Al2O3, SiO2 Si3N4) can coat the electrode material.

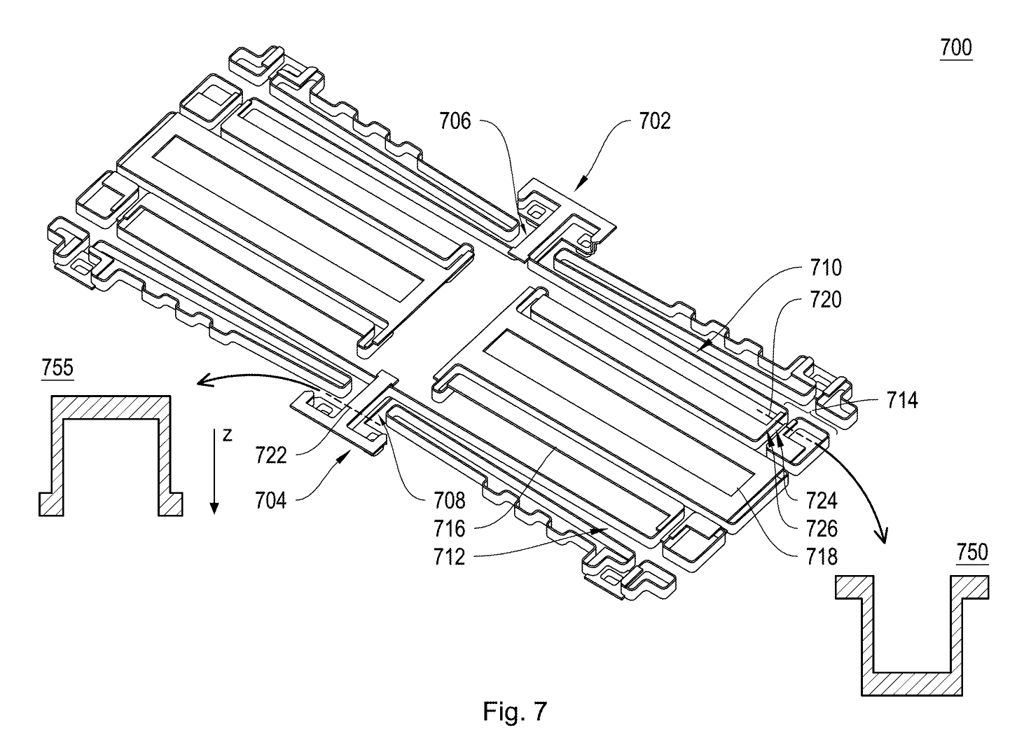

FIG. 7 shows another perspective view of an example MEMS display apparatus 700. The display apparatus 700 includes a MEMS shutter 716 of the type depicted in FIG. 2B. The display apparatus 700 may be used as the light modulators assemblies 102A-102D depicted in FIG. 1A. The MEMS shutter 716 includes an aperture 718 and is coupled to flexures 710 and 712. The flexure 710 is coupled between a connecting beam 706 and beam 726, and the flexure 712 is coupled to a connecting beam 708. The connecting beam 706 is coupled to an anchor 702 which may be connected to a substrate. The connecting beam 708 is coupled to an anchor 704 which may be coupled to the substrate. Each flexure in the display apparatus 700 includes a hinge portion. In some implementations, one or more flexures may include more than one hinge portion or no hinge portion at all. The flexure 710 includes a hinge portion 714. The hinge portion 714 includes a stiffened portion 724 coupled to a MEMS shutter 716. The cross-section 750 shows the complex cross-section of the stiffened portion 724 along the cross-section line 720. The cross-section 750 shows that the geometry of the stiffened portion is varied in the z-direction. In addition to varying the geometry of the hinge portions of the flexures, the cross-sections of the connecting rods 706 and 708 also may be varied. For example, the cross-section 755 shows the cross section of the connecting rod 708 along the cross-section line 722. As shown in the cross-section 755, the geometry of the connecting rod 708 is also varied in the z-direction. While a particular geometric cross-section is shown in the cross-sections 750 and 755, a person having ordinary skill in the art will readily understand that any suitable geometrical cross-sectional shape may be used for the flexures and the connecting rods of the MEMS display apparatus 700. The varied geometric cross-section of the connecting beams 706 and 708, as well as the varied geometric cross-sections of the flexures 710 and 712, can increase the stiffness of the flexures and the connecting rods and can reduce out-of-plane motion of the MEMS shutter 716.

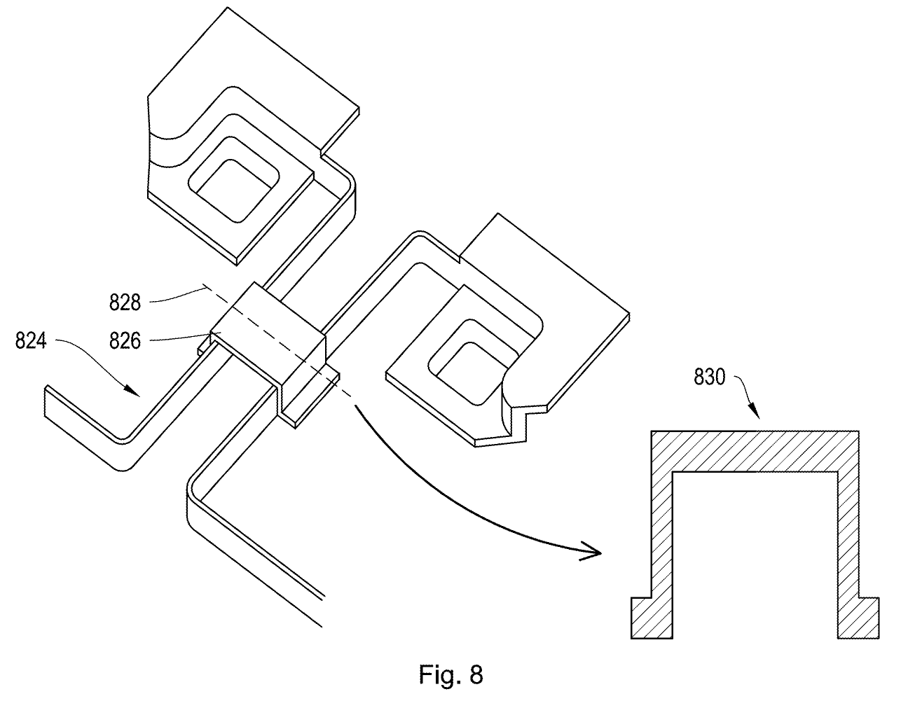

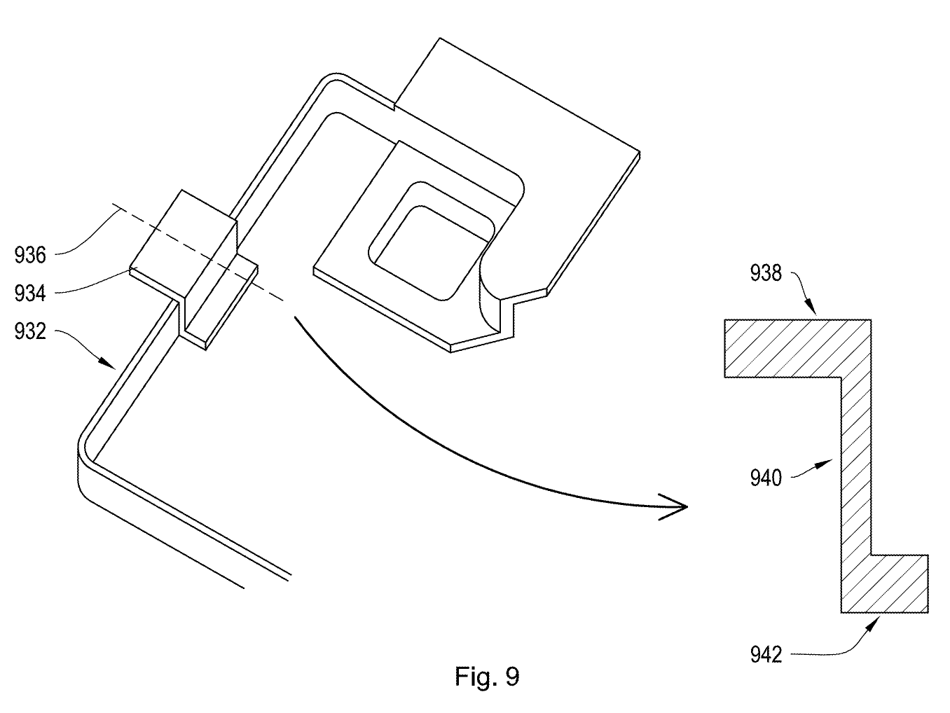

FIGS. 8 and 9 show illustrative models of example beams having complex cross-sections. FIGS. 8 and 9 illustrate examples of one of the many types of complex cross-sections that may be used to increase the stiffness of flexures. FIG. 8 illustrates a flexure beam 824 including a stiffened portion 826. The cross-section 830 shows the cross section of a stiffened portion 826 along the cross-section line 828. The stiffened portion 826 is a five-segment portion including a geometry that is raised in the z-direction. As shown in FIG. 8, the stiffened portion 826 mechanically couples a first beam 846 to a second beam 848 in the flexure 824. Also, the stiffened portion 826 is structurally independent from an anchor or a MEMS shutter. In some implementations, the stiffened portion may include more or less than five segments. For example, FIG. 9 illustrates a stiffened portion 934 coupled to a flexure beam 932 and having a three segments 938, 940 and 942. The stiffened portions 826 and 934 of FIGS. 8 and 9, respectively, may be used as part of a hinge portion or a flexure or as part of a connecting rod, as described with respect to FIG. 7.

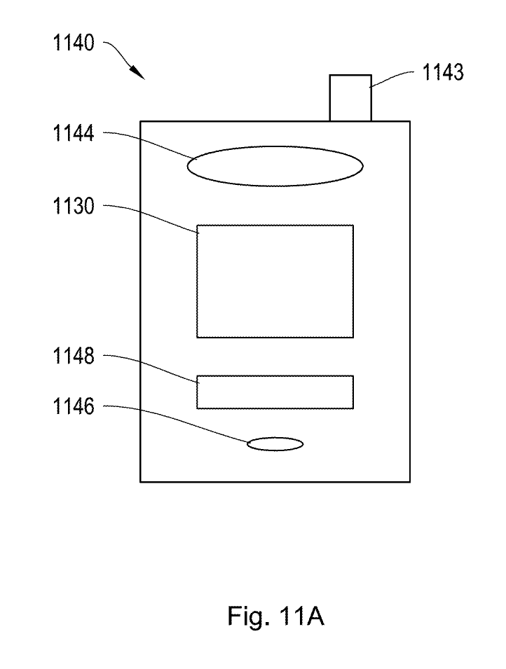

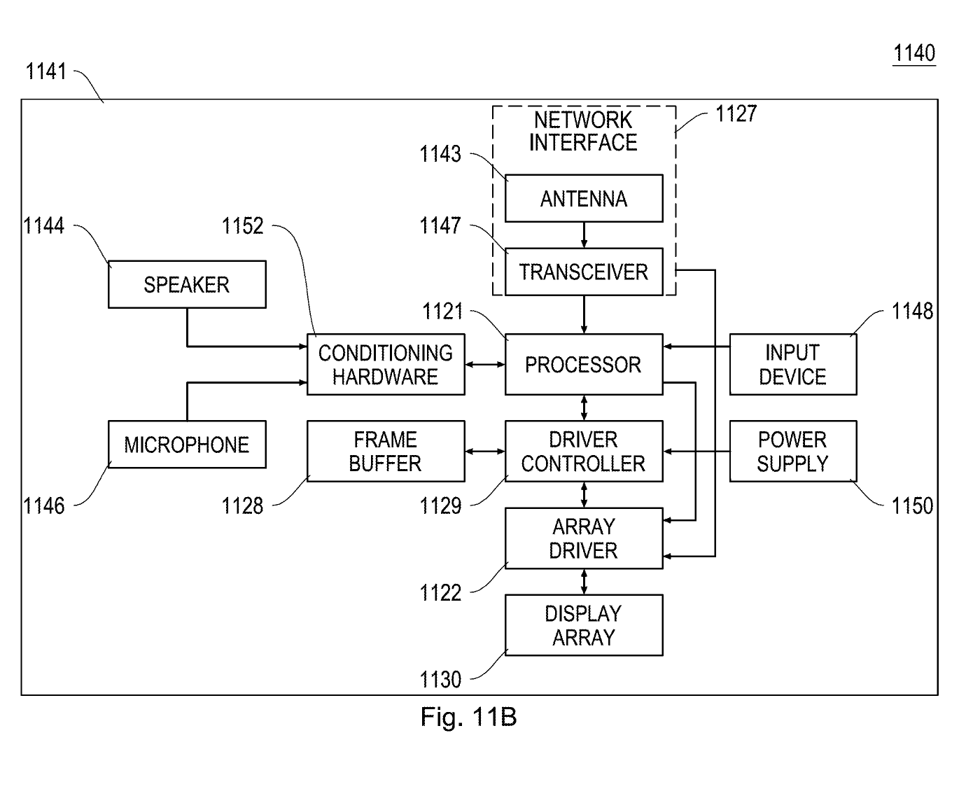

FIGS. 10A-10D show illustrative models of example cross-sections that may be used in the flexures of a shutter-based display. The cross-section illustrated in FIGS. 10A-10D may be used in the light modulators assemblies 600 and 700 of FIGS. 6 and 7. FIG. 10A shows a flexure having six segments 1002-1012, including a stiffened portion 1062. FIG. 10B shows a flexure have seven segments 1014-1026, including a stiffened portion 1063. FIG. 10C shows a flexure having eight segments 1028-1042, including a stiffened portion 1064. FIG. 10D shows a flexure having nine segments 1044-1060 including a stiffened portion 1068. In some implementations, the flexure may include more than nine segments or less than six segments. The choice of a particular implementation of cross-section can be dictated by the stiffness needed in different directions. FIGS. 11A and 11B show system block diagrams of an example display device 1140 that includes a plurality of display elements. The display device 1140 can be, for example, a smart phone, a cellular or mobile telephone. However, the same components of the display device 1140 or slight variations thereof are also illustrative of various types of display devices such as televisions, computers, tablets, e-readers, hand-held devices and portable media devices.

The display device 1140 includes a housing 1141, a display 1130, an antenna 1143, a speaker 1145, an input device 48 and a microphone 1146. The housing 1141 can be formed from any of a variety of manufacturing processes, including injection molding, and vacuum forming. In addition, the housing 1141 may be made from any of a variety of materials, including, but not limited to: plastic, metal, glass, rubber and ceramic, or a combination thereof. The housing 1141 can include removable portions (not shown) that may be interchanged with other removable portions of different color, or containing different logos, pictures, or symbols.

The display 1130 may be any of a variety of displays, including a bi-stable or analog display, as described herein. The display 1130 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 1130 can include a mechanical light modulator-based display, as described herein.

The components of the display device 1140 are schematically illustrated in FIG. 11B. The display device 1140 includes a housing 1141 and can include additional components at least partially enclosed therein. For example, the display device 1140 includes a network interface 1127 that includes an antenna 1143 which can be coupled to a transceiver 1147. The network interface 1127 may be a source for image data that could be displayed on the display device 1140. Accordingly, the network interface 1127 is one example of an image source module, but the processor 1121 and the input device 1148 also may serve as an image source module. The transceiver 1147 is connected to a processor 1121, which is connected to conditioning hardware 1152. The conditioning hardware 1152 may be configured to condition a signal (such as filter or otherwise manipulate a signal). The conditioning hardware 1152 can be connected to a speaker 1145 and a microphone 1146. The processor 1121 also can be connected to an input device 1148 and a driver controller 1129. The driver controller 1129 can be coupled to a frame buffer 1128, and to an array driver 1122, which in turn can be coupled to a display array 1130. One or more elements in the display device 1140, including elements not specifically depicted in FIG. 11A, can be capable of functioning as a memory device and be capable of communicating with the processor 1121. In some implementations, a power supply 1150 can provide power to substantially all components in the particular display device 1140 design.

The network interface 1127 includes the antenna 1143 and the transceiver 1147 so that the display device 1140 can communicate with one or more devices over a network. The network interface 1127 also may have some processing capabilities to relieve, for example, data processing requirements of the processor 1121. The antenna 1143 can transmit and receive signals. In some implementations, the antenna 1143 transmits and receives RF signals according to any of the IEEE 16.11 standards, or any of the IEEE 802.11 standards. In some other implementations, the antenna 1143 transmits and receives RF signals according to the Bluetooth® standard. In the case of a cellular telephone, the antenna 1143 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 1147 can pre-process the signals received from the antenna 1143 so that they may be received by and further manipulated by the processor 1121. The transceiver 1147 also can process signals received from the processor 1121 so that they may be transmitted from the display device 1140 via the antenna 1143.

In some implementations, the transceiver 1147 can be replaced by a receiver. In addition, in some implementations, the network interface 1127 can be replaced by an image source, which can store or generate image data to be sent to the processor 1121. The processor 1121 can control the overall operation of the display device 1140. The processor 1121 receives data, such as compressed image data from the network interface 1127 or an image source, and processes the data into raw image data or into a format that can be readily processed into raw image data. The processor 1121 can send the processed data to the driver controller 1129 or to the frame buffer 1128 for storage. Raw data typically refers to the information that identifies the image characteristics at each location within an image. For example, such image characteristics can include color, saturation and gray-scale level.

The processor 1121 can include a microcontroller, CPU, or logic unit to control operation of the display device 1140. The conditioning hardware 1152 may include amplifiers and filters for transmitting signals to the speaker 1145, and for receiving signals from the microphone 1146. The conditioning hardware 1152 may be discrete components within the display device 1140, or may be incorporated within the processor 1121 or other components.

The driver controller 1129 can take the raw image data generated by the processor 1121 either directly from the processor 1121 or from the frame buffer 1128 and can re-format the raw image data appropriately for high speed transmission to the array driver 1122. In some implementations, the driver controller 1129 can re-format the raw image data into a data flow having a raster-like format, such that it has a time order suitable for scanning across the display array 1130. Then the driver controller 1129 sends the formatted information to the array driver 1122. Although a driver controller 1129 is often associated with the system processor 1121 as a stand-alone Integrated Circuit (IC), such controllers may be implemented in many ways. For example, controllers may be embedded in the processor 1121 as hardware, embedded in the processor 1121 as software, or fully integrated in hardware with the array driver 1122.

The array driver 1122 can receive the formatted information from the driver controller 1129 and can re-format the video data into a parallel set of waveforms that are applied many times per second to the hundreds, and sometimes thousands (or more), of leads coming from the display's x-y matrix of display elements. In some implementations, the array driver 1122 and the display array 1130 are a part of a display module. In some implementations, the driver controller 1129, the array driver 1122, and the display array 1130 are a part of the display module.

In some implementations, the driver controller 1129, the array driver 1122, and the display array 1130 are appropriate for any of the types of displays described herein. For example, the driver controller 1129 can be a conventional display controller or a bi-stable display controller (such as a mechanical light modulator display element controller). Additionally, the array driver 1122 can be a conventional driver or a bi-stable display driver (such as a mechanical light modulator display element controller). Moreover, the display array 1130 can be a conventional display array or a bi-stable display array (such as a display including an array of mechanical light modulator display elements). In some implementations, the driver controller 1129 can be integrated with the array driver 1122. Such an implementation can be useful in highly integrated systems, for example, mobile phones, portable-electronic devices, watches or small-area displays.

In some implementations, the input device 1148 can be configured to allow, for example, a user to control the operation of the display device 40. The input device 1148 can include a keypad, such as a QWERTY keyboard or a telephone keypad, a button, a switch, a rocker, a touch-sensitive screen, a touch-sensitive screen integrated with the display array 1130, or a pressure- or heat-sensitive membrane. The microphone 1146 can be configured as an input device for the display device 1140. In some implementations, voice commands through the microphone 1146 can be used for controlling operations of the display device 1140. Additionally, in some implementations, voice commands can be used for controlling display parameters and settings.

The power supply 1150 can include a variety of energy storage devices. For example, the power supply 1150 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 1150 also can be a renewable energy source, a capacitor, or a solar cell, including a plastic solar cell or solar-cell paint. The power supply 50 also can be configured to receive power from a wall outlet.

In some implementations, control programmability resides in the driver controller 1129 which can be located in several places in the electronic display system. In some other implementations, control programmability resides in the array driver 1122. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical device, comprising:
a microelectromechanical systems (MEMS) flexure 400 having a first beam 412, and a second beam 418 positioned substantially parallel the first beam 412, the first beam 412 and second beam 418 extending in a first direction, and a hinge 402 located at a first end of the first beam 412 and coupling the first beam 412 to the second beam 418, the hinge 402 having:
a first hinge beam 414 extending in a second direction and transverse to the first and second beams; and
a stiffened portion 404 coupled to the first hinge beam 412 in a first location, the stiffened portion 404 including a two-dimensional surface extending in a plane substantially parallel to a first plane.

2. The electromechanical device of claim 1, wherein a cross-section of the stiffened portion is variable.

3. The electromechanical device of claim 2, wherein the stiffened portion is recessed in the z-direction.

4. The electromechanical device of claim 1, wherein a mass of the stiffened portion is varied through the z-direction.

5. The electromechanical device of claim 1, wherein the first beam is coupled to an anchor and wherein the anchor is attached to a substrate.

6. The electromechanical device of claim 1, wherein the second beam is coupled to a light modulator.

7. The electromechanical device of claim 1, wherein the hinge further includes a four-segment portion coupled to the stiffened portion.

8. The electromechanical device of claim 1, further comprising a second hinge coupling the second beam to a third beam.

9. The electromechanical device of claim 1, wherein the first direction corresponds to an x-direction, the second direction corresponds to a y-direction and the first plane corresponds to an xy-plane.

10. An electromechanical device, comprising:
an anchor 702 coupled to a substrate;
a first beam 706 extending in a first direction and coupled to the anchor 702;
a second beam 710 extending in a second direction and coupled to the first beam 706; and
a third beam 726 extending in the first direction and coupled between the second beam 710 and a light modulator 716, wherein at least one of the first beam 706, the second beam 710 and the third beam 726 is coupled to a stiffened portion 724.

11. The electromechanical device of claim 10, wherein a cross-section of the stiffened portion is variable.

12. The electromechanical device of claim 11, wherein the stiffened portion is recessed in the z-direction.

13. The electromechanical device of claim 12, wherein a mass of the stiffened portion is varied through the z-direction.

14. The electromechanical device of claim 10, wherein the stiffened portion is coupled to the anchor.

15. The electromechanical device of claim 10, wherein the stiffened portion is coupled to the light modulator.

16. The electromechanical device of claim 10, wherein the light modulator moves in the first direction and substantially parallel to the substrate.

17. An electromechanical device, comprising:
an anchor means coupled to a substrate means;
a first beam means extending in a first direction and coupled to the anchor means;
a second beam means extending in a second direction and coupled to the first beam means; and
a third beam means extending in the first direction and coupled between the second beam means and a light modulator means, wherein at least one of the first beam means, the second beam means and the third beam means is coupled to a stiffened means.

18. The electromechanical device of claim 17, wherein a cross-section of the stiffened means is variable.

19. The electromechanical device of claim 18, wherein the stiffened means is recessed in the z-direction.

20. The electromechanical device of claim 19, wherein a mass of the stiffened means is varied through the z-direction.
